(19) United States
(12) Patent Application Publication
(10) Pub. No.: US 2018/0060538 A1
(43) Pub. Date: Mar. 1, 2018

(54) CLINICAL CONNECTOR AND ANALYTICAL FRAMEWORK

(71) Applicant: PerkinElmer Informatics, Inc., Waltham, MA (US)

(72) Inventors: Abhinav Tiwari, Kanpur Uttar Pradesh (IN); Chad Millen, Guelph (CA)

(21) Appl. No.: 15/247,825

(22) Filed: Aug. 25, 2016

(51) Int. Cl. G06F 19/00; G06F 17/30

(52) U.S. Cl. CPC G06F 19/363; G06F 17/30283; G06F 17/30011

(57) ABSTRACT

Presented herein are systems, methods, and architectures related to a scalable and platform-agnostic framework that leverages multiple pluggable connectors to retrieve clinical trial data from different data sources (e.g. corresponding to different systems used to collect and manage data collected over the course of a clinical trial). The clinical connector technology described herein transforms the retrieved data to one or more standardized representations using one or more pre-defined data models. By providing clinical trial data to the client applications of stakeholders in one or more standardized formats (e.g. represented according to a standardize pre-defined data model), irrespective of the source of the clinical trial data, the systems, methods, and architectures described herein obviate the need for stakeholders to modify their workflow depending on the particular source.

### FIELD OF THE INVENTION

This invention relates generally to methods, systems, and architectures for retrieving clinical trial data from a plurality of sources.

### BACKGROUND OF THE INVENTION

Clinical trials require the collection, storage, analysis, and reporting of large quantities of complex data. Clinical trial data includes not only the observations of disease progression and treatment effectiveness required to validate a new drug, but also data such as subject demographic information, operational data, and records of adverse side effects.

Clinical trial data corresponding to observations of disease progression and treatment effectiveness obtained from measurements performed on subjects participating in a clinical trial is generally collected as a series of case report forms. The case report forms specify the type of information, such as, for example, subject identification, physical measurements, test results, question and answer responses, etc., that are to be collected. These forms are typically filled out by, e.g. medical doctors, nurses, technicians, etc., at each subject visit or interaction. Case report forms are also used to record demographics information of subjects participating in a clinical trial, as well as information related to adverse side effects experienced by subjects taking a particular drug.

Typically, different forms are designed to record different types of information. For example, a study protocol may specify a series of regularly scheduled subject visits, and, accordingly, a particular form for entering the data recorded from each visit, for each subject. Similarly, demographic information, such as subject age, ethnicity, gender, etc., may be recorded on a specific demographics form. In another example, an adverse events form may be used to record data related to any time a subject experiences an adverse side effect over the course of a study.

Recently, electronic data capture systems (EDC systems), such as Medidata Rave®, and Oracle® InForm™, have been developed to provide a way to collect this clinical trial information electronically, rather than via paper forms. These systems allow for up-to-date forms, referred to as electronic case report forms (eCRFs), for a particular study to be accessed and data to be entered into them electronically. The collected clinical trial data is thereby automatically stored in a database associated with the EDC System.

Data collected over the course of a clinical trial may also include clinical trial data that relates to the management and planning of a clinical trial, as well as financial data. For example, data related to clinical trial and site planning, the management of investigators conducting the clinical trial, study financials and payment management, as well as supply tracking are collected and used for monitoring and decision making purposes throughout a clinical trial. Often, additional third party systems, such as Clinical Trial Management Systems (CTMS) are used to collect, store, and manage such clinical trial data. A clinical trial management system (CTMS) is a software system used by biotechnology and pharmaceutical industries to manage clinical trials. Typically, the system maintains and manages planning, performing, and reporting functions, along with participant contact information, and the tracking of deadlines and milestones.

Finally, specific systems may be used to manage, store, and report portions of clinical trial data that are relevant to drug safety and pharmacovigilance activities. Drug safety and pharmacovigilance activities include the reporting of data to regulatory agencies (e.g. the U.S. Food and Drug Administration (FDA)) to ensure regulatory compliance, and often require data to be organized (e.g. represented) and stored in a specific manner, specified by a particular regulatory agency (e.g. different regulatory agencies in different countries may specify different data storage, formatting, and reporting requirements). Drug safety and pharmacovigilance systems correspond to software applications that are designed to manage and store clinical trial data in order to facilitate the activities (e.g. reporting, data storage) that are required in order to ensure regulatory compliance. Oracle® Argus is an example of a pharmacovigilance system.

Accordingly, the type and format of the data collected and used over the course of a clinical trial can vary greatly, depending on its purpose and the particular clinical systems (e.g. EDC systems, CTMSs, pharmacovigilance systems) that are used to collect, store, and manage the clinical trial data. The diversity of clinical trial data, and the corresponding diversity in the systems that are used to collect, manage, and store the data creates a significant challenge for activities that require combining, analyzing, sharing, and reporting data that originates from multiple sources corresponding to different clinical systems. In particular, each different clinical system may require a distinct, specific set of protocols to be used in order to retrieve clinical trial data. Moreover, each system may represent and store data using a distinct, system specific data model. Existing systems for collecting, managing, and storing clinical trial data do not provide functionality for retrieving and processing data from other systems. Accordingly, user interaction with a given set of clinical trial data is often limited to the functionality provided of the single, particular system that is used to collect and store that set of clinical trial data.

This approach fails to serve the needs of the variety of stakeholders involved in the clinical trial sponsor organization (e.g. a pharmaceutical company), or otherwise associated with the sponsor organization who are responsible for monitoring, analyzing, and reporting data collected over the course of the clinical trial. These stakeholders include a variety of personnel such as medical doctors, statisticians, and managers. For example, medical doctors responsible for clinical development may need to review clinical trial data daily or weekly to assess drug efficacy and/or safety. Additionally, a sponsor organization may employ data scientists to carry out biostatistics analysis of results. Furthermore, stakeholders associated with pharmacovigilance monitoring must assess and report adverse event information to drug regulatory authorities. Finally, clinical trial data related to the management, planning, and financials of a clinical trial may be analyzed by stakeholders whose duties relate to, for example, operations and supply chain management.

Requiring each stakeholder to interact with a given set of data using the particular functionality, protocols, and data representation unique to the particular systems that is used to collect, manage, and store that set of data creates a significant bottleneck when data from multiple sources and multiple clinical trials needs to be analyzed. For example, a data scientist tasked with performing biostatistics analysis on the results of several different clinical studies may be confronted with several different sets of data each of which is represented using a different data model that is associated with a different EDC system (e.g. Medidata Rave®, Oracle® InForm™).

Therefore, there exists a need for improved systems and methods for the retrieval and integration of clinical trial data from a variety of sources.

### SUMMARY OF THE INVENTION

Presented herein are systems, methods, and architectures related to a scalable and platform-agnostic framework that leverages multiple pluggable connectors to retrieve clinical trial data from different data sources (e.g. corresponding to different systems used to collect and manage data collected over the course of a clinical trial). The clinical connector technology described herein transforms the retrieved data to one or more standardized representations using one or more pre-defined data models. By providing clinical trial data to the client applications of stakeholders in one or more standardized formats (e.g. represented according to a standardize pre-defined data model), irrespective of the source of the clinical trial data, the systems, methods, and architectures described herein obviate the need for stakeholders to modify their workflow depending on the particular source. This approach also facilitates the combination of clinical trial data from a variety of different studies, each of which may collect data using a different system, and accordingly represent and store data in a different format according to a different data model.

In certain embodiments, the clinical connector technology described herein comprises an application programming interface (API) that provides a generic interface and function(s) (e.g. methods of the API) through which a software application can request and retrieve clinical trial data from a given source. The particular protocol(s) the data source uses for handling requests for data, and the format in which the requested data is provided, may be specific to the particular source from which the data is requested. However, the interface and function(s) of the API that are implemented by a software application to retrieve data remain constant. Moreover, by encapsulating the protocols specific to each source of clinical trial data within different pluggable connectors, the architecture described herein can be readily scaled to include a large number of sources of clinical trial data. In particular, the functionality to retrieve clinical trial data from a new source of clinical trial data can readily be added by adding a new pluggable connector corresponding to the new source of clinical trial data, without altering the generic interface and functions of the API through which the users and/or client applications retrieve clinical trial data.

In certain embodiments, the systems, methods, and architectures described herein map (e.g. transform the representation of) the source data (e.g. data that is represented according to the data model of the particular source from which it was retrieved), to the a pre-defined data model (e.g. specification) such as the Clinical Data Interchange Standards Consortium (CDISC) standard Study Data Tabulation Model (SDTM), a standard CTMS data model, or a simplified pharmacovigilance data model. In particular, source data is typically represented using a data model that is associated with the source of clinical trial data form which it was retrieved (e.g. the particular EDC system, or CTMS that was used to collect and manage the data). Since each source of clinical trial data may use a different data model, source data may have a variety of different representations that depend on and are unique to the specific source of clinical trial data from which it was retrieved. Accordingly, analyzing and processing different sets of source data that are retrieved from different sources of clinical trial data can be challenging and tedious due to the diversity in the different representations.

In order to address this challenge and facilitate the analysis of clinical trial data originating from multiple different sources, embodiments described herein retrieve the source data having a first representation associated with a first data model corresponding to the source of clinical trial data from which it was retrieved. The systems and method described herein then transform the representation of the source data to a second representation that is associated with one or more pre-defined second data models. The second representation of the source data that is created using a second data model is stored as mapped data. While the first data model that is used to represent source data can vary depending on the source of clinical trial data, the second data model corresponds to one of a limited number of standardized data models. This approach enables the clinical connector technology described herein to provide a client application with mapped data that is represented using a consistent data model that does not vary with the source from which it was originally retrieved. Interacting (e.g. analyzing, processing) with the mapped data as opposed to source data thus frees a user from the need to modify their workflow and/or data processing and analysis code for different sets of clinical trial data that originate from different sources.

Accordingly, embodiments described herein greatly facilitate the analysis and reporting of clinical trial data that is carried out by a variety of diverse stakeholders within or associated with a sponsor organization by enabling clinical trial data to be retrieved from a variety of sources, and transforming the retrieved source data to one or more pre-defined, standardized representations that are independent from the particular source from which the clinical trial data was retrieved. In particular, the approach described herein dramatically improves the ability of stakeholders to combine and analyze multiple sets of clinical trial data originating from multiple distinct sources.

Additionally, in certain embodiments, the systems and methods described herein aggregate multiple sets of clinical trial data into a single aggregated data set from which reports and graphical representations are generated in order to summarize and visualize trends in the data. Additionally, various embodiments described herein comprise and facilitate the use of advanced data mining and analytics (e.g. statistical modelling) techniques that identify hidden relationships between the different data elements. Data mining and analytics techniques may also be used to create new derived variables. A derived variable is not directly measured, but instead is a function of two or more data points that are directly measured. For example, the age and weight of each subject may be recorded during a clinical trial, and a derived variable corresponding to the ratio of subject weight to age could be created. Derived variables may represent useful metrics for e.g. evaluating drug efficacy or predicting a response to treatment. In certain embodiments, the analysis of data for analytics purposes is facilitated by the extracting of metadata from the retrieved clinical trial data and storing the extracted metadata in a sematic data catalog that can be searched.

Moreover, by providing a pluggable and scalable framework for retrieving and managing clinical trial data obtained from a variety of sources, the systems and methods described herein enable advanced data analysis, reporting, and visualization functionality to be provided on top of existing systems, without requiring changes to their core functionality.

Finally, in certain embodiments, the technology described herein is implemented as a web-application, or as a desktop-application using appropriate technologies (e.g. appropriate technologies for implementing a web application, such as appropriate database technologies (e.g. MongoDB®), appropriate web framework technologies (e.g. Django®, PHP), appropriate webpage design technologies (e.g. HTML, CSS, JavaScript®), e.g. appropriate technologies for implementing a desktop application such as Java™, C#). Accordingly, the systems and methods herein are not constrained to any particular platform, but rather are platform-agnostic.

Accordingly, by providing the capability to retrieve clinical trial data from a variety of sources using an API in combination with multiple pluggable connectors, and to transform the retrieved source data into one or more pre-defined, standardized data representations the systems, methods, and architectures described herein enable client applications to access and process data in a uniform fashion, regardless of the source from which it was retrieved. This approach dramatically facilitates the analysis of multiple combined sets of clinical trial data, as well as the sharing of clinical trial data between different stakeholders. Moreover, by providing these capabilities in a framework comprising pluggable connectors and modules, the clinical connector technology described herein can readily be scaled to accommodate new sources of clinical trial data. Thus, the technology described herein thereby address a significant challenge associated with the retrieval and analysis of clinical trial data originating from multiple distinct sources.

In one aspect, the invention is directed to a method for retrieving, managing, and analyzing clinical trial data from a plurality of sources, the method comprising: retrieving clinical trial data, by a processor of a computing device, from a selected one of the plurality of sources, via a function of an application programming interface (API) (e.g., method of the API) that causes the processor to: select one of a set of pluggable connectors, wherein each connector of the set is associated with a specific one of the plurality of sources of clinical trial data and comprises one or more protocols (e.g., an electronic handshake) that is/are specific to the associated source of clinical trial data; and execute instructions pursuant to the one or more protocols of the selected connector to retrieve clinical trial data from the selected source; and storing the retrieved clinical trial data, by the processor, as source data (e.g. in one or more central databases, e.g. in a database corresponding to the selected source).

In certain embodiments, the selected pluggable connector comprises one or more protocols specific to a source of clinical trial data selected from the group consisting of: an electronic data capture (EDC) system (e.g. Medidata Rave®, Oracle® InForm™); a clinical trial management system (CTMS); a pharmacovigilance (PV) system (e.g. Oracle® Argus); and a public data source (e.g. a public data source that stores data in accordance with the observational medical outcomes partnership (OMOP) common data model (CDM)).

In certain embodiments, the method comprises periodically (e.g., automatically) requesting clinical trial data from the selected source of clinical trial data via the function of the API, and storing the retrieved clinical trial data as source data, thereby updating a cache of stored source data (e.g. in one or more corresponding central databases, e.g. in a different database for each source of clinical trial data).

In certain embodiments, the method comprises storing the source data in a document-based database (e.g. MongoDB®).

In certain embodiments, the method comprises: retrieving clinical trial data from two or more selected sources of clinical trial data; aggregating the clinical trial data retrieved from the two or more selected sources into a single aggregated set of clinical trial data; and storing the aggregated set of clinical trial data for further processing and/or retrieval by a client application. In certain embodiments, the method comprises automatically generating, by a processor of a computing device, a report based on a pre-defined template, wherein the generated report comprises clinical trial data from the aggregated set of clinical trial data. In certain embodiments, the method comprises automatically generating, by a processor of a computing device, a graphical representation of clinical trial data based on a pre-defined template, wherein the graphical representation comprises clinical trial data from the aggregated set of clinical trial data.

In certain embodiments, the method comprises: extracting metadata from the retrieved clinical trial data; and storing the extracted metadata (e.g. in a semantic data catalogue) for further processing and/or retrieval by a client application.

In certain embodiments, the method comprises: retrieving, by the processor, the stored source data, wherein the retrieved source data has a first representation corresponding to a first data model associated with the source of clinical trial data from which it was retrieved; parsing, by the processor, the retrieved source data to create an intermediate representation of the source data; creating, by the processor, a second representation of the source data from the intermediate representation of the source data using a second data model; and storing the second representation of the source data as mapped data for further retrieval and/or processing.

In certain embodiments, the first data model is a data model selected from the group consisting of: a Clinical Data Interchange Standards Consortium (CDISC) Study Data Tabulation Model (SDTM); a Clinical Data Interchange Standards Consortium (CDISC) Operational Data Model (ODM); an Operational Data Model (ODM) compliant data model specific to a third party EDC system (e.g. Medidata Rave®, e.g. Oracle® InForm™); a data model specific to a third party CTMS system; and a data model specific to a third part pharmacovigilance system (e.g. Oracle® Argus). In certain embodiments, the second data model is a member selected from the group consisting of: a Clinical Data Interchange Standards Consortium (CDISC) Study Data Tabulation Model (SDTM); a Clinical Trial Management System (CTMS) compliant data model; and a safety and pharmacovigilance data model (e.g. an Oracle® Argus data model, e.g. a simplified standardized safety and pharmacovigilance data model). In certain embodiments, the second data model is a custom data model (e.g. a user defined data model).

In certain embodiments, the method comprises automatically generating, by a processor of a computing device, a report based on a pre-defined template, wherein the generated report comprises at least a portion of the mapped data. In certain embodiments, the method comprises automatically generating, by a processor of a computing device, a graphical representation of the mapped clinical trial data based on a pre-defined template, wherein the graphical representation comprises at least a portion of the mapped data.

In another aspect, the invention is directed to a system for retrieving, managing, and analyzing clinical trial data from a plurality of sources, the system comprising: a memory for storing a set of instructions; and a processor for executing the instructions, wherein the instructions, when executed, cause the processor to: retrieve clinical trial data from a selected one of the plurality of sources via a function of an application programming interface (API) (e.g., method of the API) that causes the processor to: select one of a set of pluggable connectors, wherein each connector of the set is associated with a specific one of the plurality of sources of clinical trial data and comprises one or more protocols (e.g., an electronic handshake) that is/are specific to the associated source of clinical trial data; and execute instructions pursuant to the one or more protocols of the selected connector to retrieve clinical trial data from the selected source; and store the retrieved clinical trial data, by the processor, as source data (e.g. in one or more central databases, e.g. in a database corresponding to the selected source).

In certain embodiments, the selected pluggable connector comprises one or more protocols specific to a source of clinical trial data selected from the group consisting of: an electronic data capture (EDC) system (e.g. Medidata Rave®, Oracle® InForm™); a clinical trial management system (CTMS); a pharmacovigilance (PV) system (e.g. Oracle® Argus); and a public data source (e.g. a public data source that stores data in accordance with the observational medical outcomes partnership (OMOP) common data model (CDM)).

In certain embodiments, the instructions cause the processor to periodically (e.g., automatically) retrieve clinical trial data from the selected source of clinical trial data via the function of the API, and store the retrieved clinical trial data as source data, thereby updating a cache of stored source data (e.g. in one or more corresponding central databases, e.g. in a different database for each source of clinical trial data). In certain embodiments, the instructions cause the processor to store the source data in a document-based database (e.g. MongoDB®).

In certain embodiments, the instructions cause the processor to: retrieve clinical trial data from two or more selected sources of clinical trial data; aggregate the clinical trial data retrieved from the two or more selected sources into a single aggregated set of clinical trial data; and store the aggregated set of clinical trial data for further processing and/or retrieval by a client application. In certain embodiments, the instructions cause the processor to automatically generate a report based on a pre-defined template, wherein the generated report comprises clinical trial data from the aggregated set of clinical trial data. In certain embodiments, the instructions cause the processor to automatically generate a graphical representation of clinical trial data based on a pre-defined template, wherein the graphical representation comprises clinical trial data from the aggregated set of clinical trial data.

In certain embodiments, the instructions cause the processor to: extract metadata from the retrieved clinical trial data; and store the extracted metadata (e.g. in a semantic data catalogue) for further processing and/or retrieval by a client application.

In certain embodiments, the instructions cause the processor to: retrieve the stored source data, wherein the retrieved source data has a first representation corresponding to a first data model associated with the source of clinical trial data from which it was retrieved; parse the retrieved source data to create an intermediate representation of the source data; create a second representation of the source data from the intermediate representation of the source data using a second data model; and store the second representation of the source data as mapped data for further retrieval and/or processing. In certain embodiments, the first data model is a data model selected from the group consisting of: a Clinical Data Interchange Standards Consortium (CDISC) Study Data Tabulation Model (SDTM); a Clinical Data Interchange Standards Consortium (CDISC) Operational Data Model (ODM); an Operational Data Model (ODM) compliant data model specific to a third party EDC system (e.g. Medidata Rave®, e.g. Oracle InForm™); a data model specific to a third party CTMS system; and a data model specific to a third part pharmacovigilance system (e.g. Oracle® Argus). In certain embodiments, the second data model is a member selected from the group consisting of: a Clinical Data Interchange Standards Consortium (CDISC) Study Data Tabulation Model (SDTM), a Clinical Trial Management System (CTMS) compliant data model, and a safety and pharmacovigilance data model (e.g. an Oracle Argus data model, e.g. a simplified standardized safety and pharmacovigilance data model). In certain embodiments, the second data model is a custom data model (e.g. a user defined data model).

In certain embodiments, the instructions cause the processor to automatically generate a report based on a pre-defined template, wherein the generated report comprises at least a portion of the mapped data. In certain embodiments, the instructions cause the processor to automatically generate a graphical representation of the mapped clinical trial data based on a pre-defined template, wherein the graphical representation comprises at least a portion of the mapped data.

In another aspect, the invention is directed to a clinical connector system for retrieving, managing, and analyzing clinical trial data from a plurality of sources, the system comprising: a data services module for retrieving clinical trial data from a plurality of sources and storing the retrieved clinical trial data as source data (e.g. in one or more central databases, e.g. in a database corresponding to the selected source), the data services module comprising an application programming interface (API) for: selecting one of a set of pluggable connectors, wherein each connector of the set is associated with a specific one of the plurality of sources of clinical trial data and comprises one or more protocols (e.g., an electronic handshake) that is/are specific to the associated source of clinical trial data; and retrieving clinical trial data from the selected source pursuant to the one or more protocols of the selected connector.

In certain embodiments, the set of pluggable connectors comprises one or more protocols specific to a source of clinical trial data selected from the group consisting of: an electronic data capture (EDC) system (e.g. Medidata Rave®, Oracle® InForm™); a clinical trial management system (CTMS); a pharmacovigilance (PV) system (e.g. Oracle® Argus); and a public data source (e.g. a public data source that stores data in accordance with the observational medical outcomes partnership (OMOP) common data model (CDM)).

In certain embodiments, the data services module periodically (e.g., automatically) requests clinical trial data from the selected source of clinical trial data via a function of the API, and stores the retrieved clinical trial data as source data, thereby updating a cache of stored source data (e.g. in one or more corresponding central databases, e.g. in a different database for each source of clinical trial data).

In certain embodiments, the data services module stores the retrieved clinical trial data as source data in a document-based database (e.g. MongoDB®).

In certain embodiments, the data services module: retrieves clinical trial data from two or more selected sources of clinical trial data; aggregates the clinical trial data retrieved from the two or more selected sources into a single aggregated set of clinical trial data; and stores the aggregated set of clinical trial data for further processing and/or retrieval by a client application. In certain embodiments, the system comprises a reporting module for automatically generating, by a processor of a computing device, a report based on a pre-defined template, wherein the generated report comprises clinical trial data from the aggregated set of clinical trial data. In certain embodiments, the system comprises a visualization module for automatically generating, by a processor of a computing device, a graphical representation of clinical trial data based on a pre-defined template, wherein the graphical representation comprises clinical trial data from the aggregated set of clinical trial data. In certain embodiments, the system comprises a semantic data catalogue module for extracting metadata from the retrieved clinical trial data, and storing the extracted metadata for further processing and/or retrieval by a client application.

In certain embodiments, the system comprises a mapping module for: retrieving the stored source data, wherein the retrieved source data has a first representation corresponding to a first data model associated with the source of clinical trial data from which it was retrieved; creating a second representation of the retrieved source data using a second data model; and storing the second representation of the retrieved source data as mapped data (mapped between the first representation and second representation) for further retrieval and/or processing. In certain embodiments, the first data model is one of a plurality of source data models, each source data model associated with a specific one of the plurality of sources of clinical trial data, the mapping module comprises a plurality of parsers, and creating the second representation of the retrieved source data using a second data model comprises selecting a parser that is associated with the first data model and executing the instructions of the selected parser to parse the source data, create an intermediate representation, and create the second representation, wherein: the selected parser is one of the plurality of parsers, each parser is associated with a specific one of the plurality of source data models, and each parser comprises instructions which, when executed by a processor of a computing device, cause the processor to: parse source data having a representation corresponding to the specific source data model with which the parser is associated to create an intermediate representation of the source data; and create the second representation of the source data from the intermediate representation of the source data using the second data model.

In certain embodiments, the system comprises one or more specifications modules, wherein the first data model is one of a plurality of source data models, each source data model associated with a specific one of the plurality of sources of clinical trial data, the second data model is one of one or more standardized data models, the mapping module comprises a plurality of parsers, and creating the second representation of the retrieved source data using the second data model comprises: (i) selecting a parser that is associated with the first data model and executing the instructions of the selected parser to create an intermediate representation of the source data, wherein: the selected parser is one of the plurality of parsers, each parser is associated with a specific one of the plurality of source data models, and each parser comprises instructions which, when executed by a processor of a computing device, cause the processor to: parse source data having a representation corresponding to the specific source data model with which the parser is associated to create an intermediate representation of the source data; and (ii) selecting a specifications module that is associated with the second data model to create the second representation from the intermediate representation, wherein: the selected specifications module is one of the one or more specifications modules, each of the one or more specifications modules is associated with a specific one of the one or more standardized data models, and each specifications module comprises instructions which, when executed by a processor of a computing device, cause the processor to create a representation of the source data from the intermediate representation of the source data using the specific standardized data model with which the specifications module is associated.

In certain embodiments, the first data model is a data model selected from the group consisting of: a Clinical Data Interchange Standards Consortium (CDISC) Study Data Tabulation Model (SDTM); a Clinical Data Interchange Standards Consortium (CDISC) Operational Data Model (ODM); an Operational Data Model (ODM) compliant data model specific to a third party EDC system (e.g. Medidata Rave®, e.g. Oracle® InForm™); a data model specific to a third party CTMS system; and a data model specific to a third part pharmacovigilance system (e.g. Oracle® Argus). In certain embodiments, the second data model is a member selected from the group consisting of: a Clinical Data Interchange Standards Consortium (CDISC) Study Data Tabulation Model (SDTM), a Clinical Trial Management System (CTMS) compliant data model, and a safety and pharmacovigilance data model (e.g. an Oracle® Argus data model, e.g. a simplified standardized safety and pharmacovigilance data model). In certain embodiments, the second data model is a custom data model (e.g. a user defined data model).

In certain embodiments, the system comprises a reporting module for automatically generating, by a processor of a computing device, a report based on a pre-defined template, wherein the generated report comprises at least a portion of the mapped data.

In certain embodiments, the system comprises a visualization module for automatically generating, by a processor of a computing device, a graphical representation of the mapped clinical trial data based on a pre-defined template, wherein the graphical representation comprises at least a portion of the mapped data.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram showing the organization of components and subsystems associated with a clinical connector technology architecture, according to an illustrative embodiment.

FIG. 2 is a block diagram showing the organization of an application programming interface (API) and multiple pluggable connectors associated with a clinical connector technology according to an illustrative embodiment.

FIG. 3 is a block flow diagram of a process for mapping source data having a first representation corresponding to a first data model to a second representation corresponding to a second data model according to an illustrative embodiment.

FIG. 4 is a block diagram of an exemplary cloud computing environment, used in certain embodiments.

FIG. 5 is a block diagram of an example computing device and an example mobile computing device used in certain embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### Definitions

Clinical Study, Clinical Trial: As used herein, the terms “clinical trial,” “clinical study,” and “study,” refer to research studies that test, for example, how well new medical approaches work in human subjects. The number of subjects is typically governed by the duration and type of the study. Clinical trial data includes, without limitation, operational data and clinical data, as well as other data collected and managed over the course of a clinical trial, such as data that relates to the management and planning of a clinical trial, and financial data. For example, data related to clinical trial and site planning, the management of investigators conducting the clinical trial, study financials and payment management, as well as supply tracking are collected and used for monitoring and decision making purposes throughout a clinical trial. Clinical trial data also includes additional data from outside sources, such as public data sources (e.g. electronic medical records, and administrative claims data) that may be used in combination with the recorded clinical data in order to analyze clinical data (e.g. to compare the efficacy of the drug under test with existing treatments, e.g. to make predictions with regard to how the drug under test may perform in combination with existing treatments).

Subject: As used herein, the term “subject” refers to a human subject (e.g. a patient) in a clinical trial.

Study events: As used herein, the term “study event” refers to any of one or more events occurring over the course of a clinical trial that results in the collection of clinical trial data for one or more difference subjects. Each study event differs from other study events in terms of the purpose of the study event, and, accordingly, the different electronic case report forms (eCRFs) that are used to collect the clinical trial data for that event. The number and types of study events are defined during the clinical trial design.

Electronic Data Capture (EDC): As used herein, the terms “electronic data capture,” and “EDC” refer to the process of recording and storing clinical trial data electronically. Clinical trial data is generally collected as a series of case report forms (CRFs). The CRFs are designed specifically for each study, based on the particular protocol(s) to be followed during the study. The CRFs specify the type of information, such as, for example, subject identification, physical measurements, test results, question and answer responses, etc., that are to be collected. These forms are typically filled out by, e.g. medical doctors, nurses, technicians, etc., at each study event for a particular subject (e.g. a subject visit to a doctor, or other interaction, such as reporting demographics information). In an EDC process, the CRFs are electronic forms (eCRFs) and data is entered into them electronically (e.g. on a computer, or a mobile device). Once entered, the data for each individual form (e.g. the particular form containing the data for a given study event and subject) is stored electronically.

Clinical trial management system, CTMS: As used herein, the term “Clinical Trial Management System” or “CTMS” refers to a software application that is used to manage clinical trials. In particular a CTMS manages data relevant to, and provides software functions that facilitate clinical program/project management, trial and site planning, site and subject management, study management, investigator management. A CTMS also may provide software functionality for managing data related to study financials, investigator grants, and payment management. Finally, in certain embodiments, a CTMS includes functionality for supply management including supply tracking, as well as clinical trial performance and reporting.

Pharmacovigilence, pharmacovigilence systems: As used herein, the term “pharmacovigilance” refers to the science, and activities relating to the detection, assessment, understanding, and prevention of adverse side effects, and other drug-related problems. As used herein, the term “pharmacovigilance systems” (e.g. also known as ‘drug safety’ systems), refers to software applications that manage the collection, analysis, and reporting of data related to the detection, assessment, monitoring, and prevention of adverse effects of pharmaceutical products. Pharmacovigilance systems aim to enhance patient care and patient safety in relation to the use of pharmaceutical drugs, and to support public health programs by providing reliable, balanced information for the effective assessment of the risk-benefit profile of medicines.

Form: As used herein, the term “form” refers to a pre-defined template (e.g. a case report form as used in a clinical trial, e.g. an eCRF) that identifies a set of data to be recorded during a study event. A form is analogous to a page in a paper CRF book or an electronic CRF (eCRF) screen.

In certain embodiments, a form comprises a list of fields (e.g. age, weight, race, gender, blood pressure, cholesterol levels, hemoglobin levels) for which values are to be collected for each subject during a specific study event. The fields belonging to a particular form are typically logically or temporally related. For example, a demographics form may list fields such as age, gender, and ethnicity, while a physical examination form may list fields such as height, weight and systolic blood pressure. In another example, an adverse events form may identify (e.g. list) the fields for which data should be collected when a subject experiences an adverse event.

A set of data collected using a particular form comprises values for each of the fields identified by that form. For example, a set data collected using a demographic comprises values (e.g. recorded for a particular subject, during a particular study event) for each of the fields that the demographics form comprises, such as age, gender, and ethnicity.

Different forms are used to record data taken during different study events. Each study event may identify one or more forms using which data are collected during that study event.

Form entry: As used herein, the term “form entry” refers to the set of data that is recorded for a particular subject, at a particular study event, using a particular form. A form entry collected using a particular form is referred to herein as belonging to that form. Similarly, a form entry collected for a particular study event is referred to herein as belonging to that study event. Similarly, a form entry collected for a particular subject is referred to herein as belonging to that subject. Finally, a form entry collected as part of a particular study is referred to herein as belonging to that study. Accordingly, data for a clinical trial comprises a series of form entries.

Item: As used herein, the term “item” refers to an individual clinical data item, such as the age of a single subject or a single systolic blood pressure reading.

Operational data: As used herein, the term “operational data” refers to data having to do with the process of creation, deletion, recordation, and/or modification of clinical data collected during a clinical trial. Non-limiting examples of operational data include audit records, queries, and signatures. For example, an audit record may comprise information such as who performed a particular action such as the creation, deletion, or modification of clinical data, as well as where, when, and why that action was performed. In another example, operational data comprises an electronic signature applied to a collection of clinical data. The electronic signature identifies a user that accepts legal responsibility for that data. The electronic signature may comprise an identification of the person signing, the location of signing, and the date and time of signing. In certain embodiments, the electronic signature comprises a meaning of the signature as defined via the U.S. Food and Drug Administration guidelines under 21 C.F.R. Part 11. The signature meaning may be included in an XML element, such as “SignatureDef”, in accordance with the CDISC Operational Data Model Specification. In certain embodiments, in the case of a digital signature, the signature comprises an encrypted hash of the included data.

By contrast, data collected during a clinical trial such as observations by a medical practitioner of disease progression in a subject, demographic information about a subject, records of side effects, medical test results, and the like is referred to herein as “clinical data”. The term “clinical trial data” encompasses both clinical data and operational data.

Provide: As used herein, the term “provide”, as in “providing data”, refers to a process for passing data in between different software applications, modules, systems, and/or databases. In certain embodiments, providing data comprises the execution of instructions by a process to transfer data in between software applications, or in between different modules of the same software application. In certain embodiments a software application may provide data to another application in the form of a file. In certain embodiments an application may provide data to another application on the same processor. In certain embodiments standard protocols may be used to provide data to applications on different resources. In certain embodiments a module in a software application may provide data to another module by passing arguments to that module.

### DETAILED DESCRIPTION

It is contemplated that systems, architectures, devices, methods, and processes of the claimed invention encompass variations and adaptations developed using information from the embodiments described herein. Adaptation and/or modification of the systems, architectures, devices, methods, and processes described herein may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Documents are incorporated herein by reference as noted. Where there is any discrepancy in the meaning of a particular term, the meaning provided in the Definition section above is controlling.

The systems and methods described herein relate to a scalable framework that enables clinical trial data to be retrieved from a plurality of sources, and facilitates the analysis of clinical trial data.

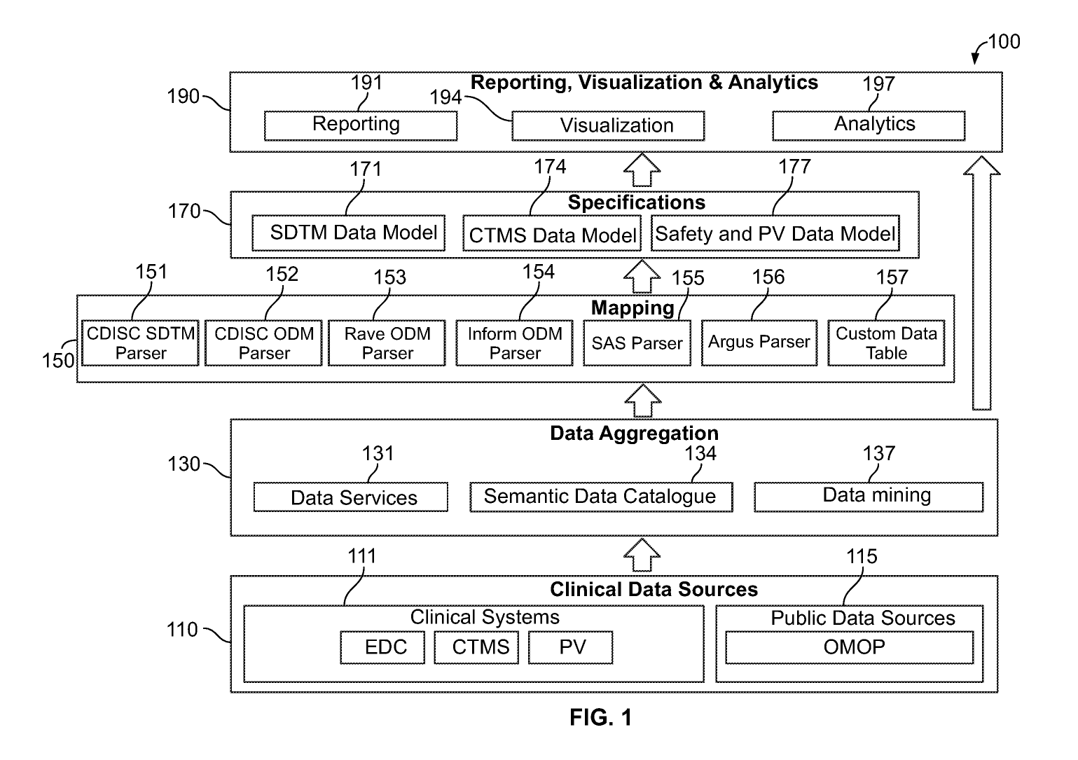

FIG. 1 is a block flow diagram showing the organization of components and subsystems associated with a system architecture for implementing the clinical connector technology according to an illustrative embodiment. As shown in FIG. 1, the architecture 100 comprises a data aggregation layer 130, a data mapping module 150, a specifications layer 170, and a reporting, visualization and analytics module 190.

In certain embodiments, the clinical connector technology described herein retrieve data from one or more different sources of clinical trial data 110, including EDC systems, CTMSs, and pharmacovigilance systems 111.

In certain embodiments, the systems and methods described herein also enable the retrieval of data from public data sources 115. In particular, public data sources may comprise electronic medical records (EMRs), and administrative claims data. EMRs are aimed at supporting clinical practice at the point of care, while administrative claims data is related to the insurance reimbursement processes. Typically, each observational dataset (e.g. EMR data or administrative claims data) is collected for a different purpose, resulting in data that is represented using different logical organizations, physical formats, and terminologies (e.g. terms used to describe the medicinal products and clinical conditions). The Observational Medical Outcomes Partnership (OMOP) provides a Common Data Model (CDM) that provides a common data model (e.g. including terminologies, vocabularies, and coding schemes) for representing data corresponding to EMRs and administrative claims data in a standardized format. The OMOP CDM thereby facilitates the analysis of data such as EMRs and administrative claims data. Accordingly, in certain embodiments, data from disparate observational databases is first transformed into CDM before being stored in a CDM compliant system.

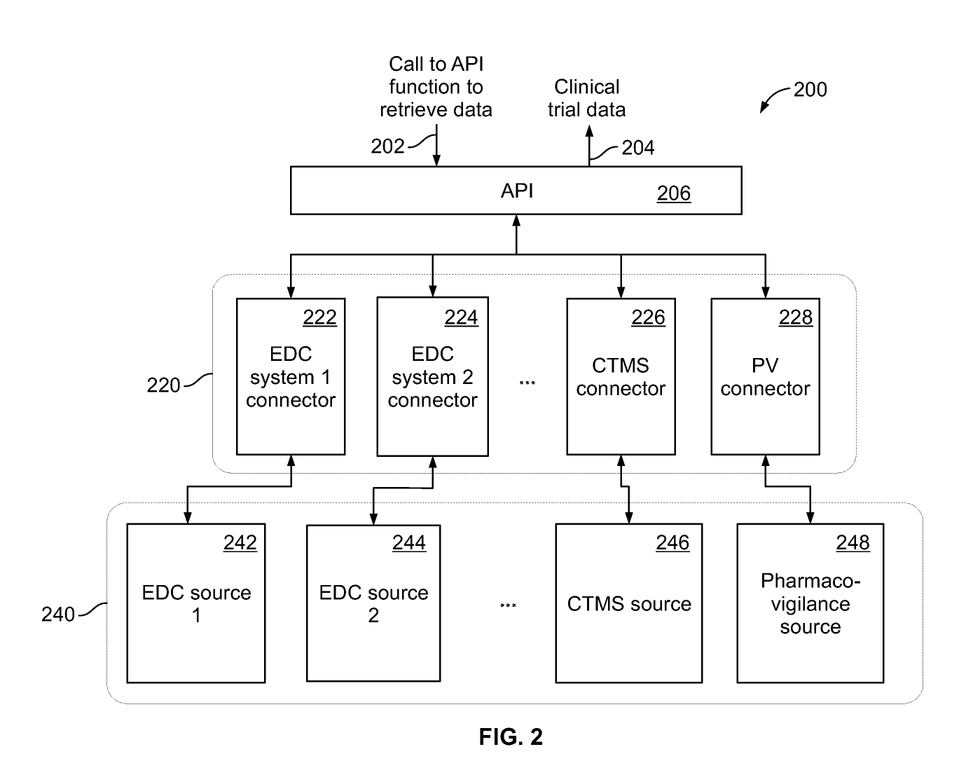

In certain embodiments, as shown in FIG. 2, the technology described herein comprises a framework 200 that uses an application programming interface (API) 206 to retrieve data from the sources of clinical trial data 242, 244, 246, 248 (collectively 240) via one or more pluggable connectors 222, 224, 226, 228 (collectively 220). In particular, each pluggable connector is associated with a different source of clinical trial data, such as a particular EDC system (e.g. Medidata Rave®, Oracle® InForm™), a CTMS, a pharmacovigilance source (e.g. Oracle® Argus), or a public data source (e.g. a public data source that provides data conformant to the OMOP CDM, e.g. a source of electronic medical records). Typically, the process of requesting and retrieving clinical trial data from a particular source of clinical trial data requires the use of specific instructions that conform to the data transfer protocols that the particular source uses. As each source may rely upon a different set of protocols for transferring data, requesting and retrieving clinical trial data from multiple sources requires multiple different sets of instructions that must be executed in order to request and retrieve data from each source.

By utilizing multiple pluggable connectors 220, each of which is associated with a different source of clinical trial data, in combination with an API 206, the connector technology described herein provide an abstraction of the underlying connection methodologies that are specific to each different source of clinical trial data. The abstraction enables a client application to access, request, and retrieve clinical trial data from multiple different sources of clinical trial data 240 in a uniform fashion through the API 206, thereby obviating the need for a client application to use, or include code that implements the specific instructions pursuant to the particular protocols and connection methodologies of a given source of clinical trial data.

In particular, in certain embodiments each connector 220 corresponds to a software module that comprises one or more protocols for retrieving clinical trial data from a particular source of clinical trial data with which it is associated. Instead of requesting data directly from a particular source of clinical trial data using a set of instructions (e.g. software commands) that are specific to that source of clinical trial, a user or client application may call a function of the API (e.g. an API method) and specify a particular selected source of clinical trial data from which to retrieve data (202). When executed (e.g. by a processor), the function of the API (e.g. an API method) selects the appropriate connector that is associated with the selected source of clinical trial data, and executes instructions pursuant to the one or more protocols of the selected connector to retrieve the clinical trial data from the selected source of clinical trial data (204).

In this manner, the API provides a generic interface and functions(s) (e.g. API methods) through which a client application can request (202) and retrieve clinical trial data (204) from a given source, irrespective of the particular data source, the protocols the data source uses for handling requests for data, and the format in which the requested data is stored. Moreover, by encapsulating the protocols specific to each source of clinical trial data within different pluggable connectors 220, the architecture described herein can be readily scaled to include a large number of sources of clinical trial data 240. In particular, the functionality to retrieve clinical trial data from a new source of clinical trial data can readily be added by adding a new pluggable connector corresponding to the new source of clinical trial data, without altering the generic interface and functions of the API 206 through which the client applications retrieve clinical trial data (204).

In certain embodiments, the architecture described herein comprises a data aggregation layer 130 that comprises a data services module 131, a semantic data catalogue module 134, and a data mining module 137. In certain embodiments, the data services module 131 retrieves and stores clinical trial data from the one or more sources of clinical trial data.

In certain embodiments, the data services module 131 retrieves clinical trial data in response to a request for clinical trial data (e.g. from a client application), and stores the retrieved clinical trial data as source data. In certain embodiments, once the clinical trial data is retrieved, the data services module 131 serves the retrieved clinical trial data to a client application (e.g. the client application that requested the clinical trial data).

In certain embodiments, the data services module 131 retrieves clinical trial data from multiple different sources of clinical trial data, such as SDTM and CDISC Operational Data Model (ODM) compliant data sources, and aggregates the retrieved clinical trial data into a single set of aggregated clinical trial data. The data services module 131 then provides the aggregated clinical trial data to a client application.

In certain embodiments, the data services module 131 periodically retrieves clinical trial data from one or more sources of clinical trial data and stores the retrieved data, thereby maintaining an up-to-date cache of clinical trial data for retrieval and/or further processing by a client application. Examples of detailed systems, methods, and architectures for caching clinical trial data in this manner are provided in U.S. patent application Ser. No. 15/233,847 “Caching Technology for Clinical Data Sources”, the content of which is hereby incorporated herein by reference in its entirety.

By maintaining an up-to-date cache of clinical trial data in this manner, the systems, methods, and architectures described herein improve the speed with which clinical trial data can be retrieved by a client application. In particular, this approach reduces the quantity of clinical trial data that needs to be retrieved from a given source of clinical trial data in response to a request for data (e.g. only the portion of the data that has not already been retrieved and stored in the cache needs to be retrieved from the source) and reduces the bottlenecks that are produced by sources that suffer from poor performance in terms of the retrieval rate that they provide (e.g. the rate at which data can be retrieved from the source).

In certain embodiments, the data services module 131 uses a database system such as a relational database management system (e.g. Microsoft® SQL Server) for data storage and administration. In certain embodiments, the data services module uses a document-based database, such as MongoDB® for data storage.

In certain embodiments, the data aggregation layer 130 comprises a semantic data catalogue 134. The semantic data catalogue 134 extracts metadata from the clinical trial data that is retrieved from different sources of clinical trial data, and stores the extracted metadata. Additionally, in certain embodiments, the semantic data catalogue catalogs, identifies, and unifies the metadata that it stores, thereby facilitating the application of analytics to the retrieved clinical trial data.

In certain embodiments, the data aggregation layer 130 also comprises a data mining module 137 that implements data mining techniques in order to extract useful information and patterns in the retrieved clinical trial data. In particular, data mining methods can be used to identify hidden patterns and relationships among different data points stored in sets of clinical trial data. In general, data mining methods analyze data from different perspectives, and summarize the data to extract useful information. In certain embodiments, objectives of data mining techniques that are applied to clinical trial data may include understanding the clinical data (e.g. determining the efficacy of a particular drug), assisting healthcare professionals, and developing a data analysis methodology suitable for medical data.

In certain embodiments, the information extracted via data mining is used to increase revenue, cuts costs, or both. In certain embodiments, data mining methods are used to extract information, such as relationships between different drugs, and the effects that are observed in the data collected during a clinical trial in order to improve drugs safety (e.g. relevant for pharmacovigilance activities), clinical outcomes (e.g. the efficacy of a particular drug or combination of drugs, e.g. identify particular subject cohorts based on demographics information that respond differently to certain drugs). Data mining methods may also be used to improve the efficacy of the overall clinical trial process.

In certain embodiments, the systems, methods, and architectures described herein comprise a mapping module 150 that maps (e.g. transforms the representation of) source data that is retrieved from data aggregation module 130, to a pre-defined data model (e.g. specification) such as SDTM, a CTMS data model, or a standardized pharmacovigilance data model. In particular, source data is typically represented using a data model that is associated with the source of clinical trial data form which it was retrieved (e.g. a specific source data model). Since each source of clinical trial data may use a different data model, source data may have a variety of different representations, depending on, and unique to the specific source of clinical trial data from which it was retrieved. Accordingly, analyzing and processing different sets of source data that are retrieved from different sources of clinical trial data can be challenging and tedious due to the diversity in the different representations.

In certain embodiments, in order to address this challenge and facilitate the analysis of clinical trial data originating from multiple different sources, the mapping module 150 may retrieve the source data having a first representation associated with a first data model that is associated with the source of clinical trial data and transform its representation to a second representation that is associated with one or more pre-defined second data models. The second representation of the source data that is created using a second data model is stored as mapped data. While the first data model that is used to represent source data can vary depending on the source of clinical trial data (e.g. the first data model may be one of a plurality of source data models), the second data model may correspond to one of a limited number of fixed, standardized data models. Accordingly, a client application can be used to analyze mapped data using a fixed process and fixed code that processes data represented according to one of the standardized second data models, while remaining agnostic to source of clinical trial data.

In certain embodiments, the second data model may be a standardized data model such as the CDISC SDTM, a CTMS data model, or a standardized safety and pharmacovigilance data model. For example, the SDTM data model provides a standard for organizing, and formatting clinical trial data in order to streamline the processes of clinical trial data collection, management, analysis, and reporting. Representing and storing mapped data in a uniform fashion through the SDTM facilitates activities and functions such as data aggregation and warehousing, data mining, and data reuse. Moreover, the standard SDTM format facilitates data sharing between multiple stakeholders and client applications as well as due diligence and other important data review activities. Finally, because SDTM is one of the required standards that sponsors must use as specified in the FDA's Data Standards Catalog, storing clinical trial data as mapped data according to the SDTM data model facilitates the regulatory review and approval process.

In certain embodiments, the SDTM can also be used to represent non-clinical data, data collected relevant to the testing of medical devices, and data from pharmacogenomics and genetics studies.

In certain embodiments, the source data is transformed into a second representation corresponding to the CTMS data model and stored as mapped data. The CTMS data model may be used to represent a wider variety of data that is collected and used over the course of a clinical trial. In particular, the CTMS data model enables the representation of data related to clinical program/project management, trial and site planning, site and subject management, study management, investigator management, study financials, investigator grants and payment management, clinical supply management including supply tracking, and clinical trial performance and reporting.

In certain embodiments, source data that is relevant to drug safety and pharmacovigilance activities is transformed to a second representation corresponding to a safety and pharmacovigilance data model, and stored as mapped data. A safety and pharmacovigilance data model enables the representation of data specific to drug safety and pharmacovigilance requirements.

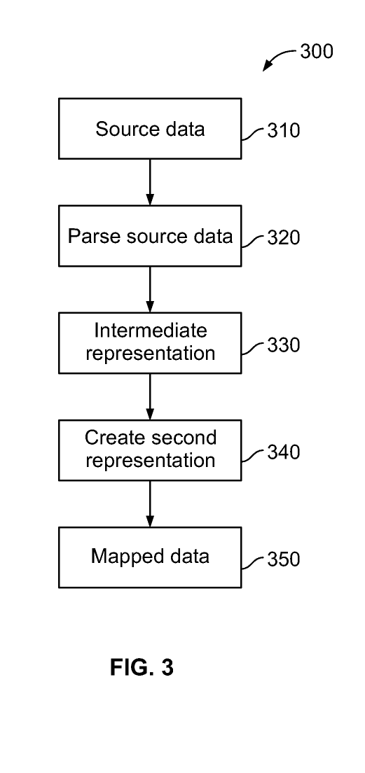

FIG. 3 shows an example process 300 for transforming the representation of source data to a second representation. In particular, in certain embodiments the mapping module 150 transforms the representation of source data to a second representation using one or more of the pre-defined second data models by retrieving the source data 310 and parsing the retrieved source data (320) to create an intermediate representation 330 of the source data. The intermediate representation may be used to represent the source data internally, for example, within the computer routine that parses the source data. In order to transform the representation of the source data from its first, original representation that is associated with the source of clinical trial data from which it was retrieved, the mapping module 150 creates a second representation of the source data (340) from the intermediate, internal representation using a second data module such as the SDTM, CTMS data model, or a standard safety and pharmacovigilance data model. The second representation of the source data is then stored as mapped data 350 for further retrieval and/or processing, such as by a client application.

In certain embodiments, the mapping module 150 comprises multiple pluggable parsers (151, 152, 153, 154, 155, 156), each of which is associated with a particular data model that is used by a specific source of clinical trial data. Each parser parses source data that originates from the specific source of clinical trial data with which the parser is associated, creates an intermediate representation of the source data, and creates a second representation of the source data from the intermediate representation using one of the second data models. Accordingly, each pluggable parser encapsulates the specific instructions and functionality required to parse source data that is represented according to a particular data model associated with the source of clinical trial data from which it was retrieved. In order to accommodate multiple different sources of clinical trial data, multiple parsers are used, with each parser corresponding to a specific source of clinical trial data. Therefore, the framework can readily be scaled to parse source data retrieved from new sources of clinical trial data simply by adding additional pluggable parsers.

For example, a CDISC SDTM parser 151 is used to parse the source data that is represented using a CDSC SDTM compliant data model, and create a second representation of the source data using one of the pre-defined second data models. Similarly, a CDISC ODM parser 152 parses source data that is retrieved from sources of clinical trial data that provide source represented using the ODM data model, and creates a second representation of the source data using one of the pre-defined second data models. A Rave® ODM parser 153 parses source data that originates from a Medidata Rave® source and is represented according the Medidata Rave® ODM data model, and creates a second representation of the source data using one of the pre-defined second data models. Similarly, an Inform ODM parser 154 retrieves source data from an Oracle® InForm™ source, wherein the source data is represented according to an ODM data model specific to Oracle® InForm™. The Inform ODM parser parses source data retrieved from an Oracle® InForm™ source and creates a second representation of the source data using one of the pre-defined second data models. Another example of a parser is a SAS® parser 155 that retrieves source data that originated from a SAS® compliant data source and, accordingly, has a representation corresponding to a data model associated with one of the SAS® data formats (e.g. .sas7bdat, .xpt).

A final example of a parser is an Argus parser 156 that transforms the representation of source data retrieved from an Oracle® Argus source. The Oracle® Argus parser is particularly relevant to safety and pharmacovigilance data. In particular, Oracle® Argus is a pharmacovigilance system that enables drug manufacturers to make faster and better safety decisions, optimize global compliance, and integrate risk management into key processes. Oracle® Argus is primarily used to create clinical trials and to create a database of clinical trial data that can be used to conduct pharmacovigilance activities. The Argus parser parses source data retrieved from an Oracle® Argus source, and creates a second representation using a simplified safety and pharmacovigilance data model that structures safety data in order to facilitate further analysis.

In certain embodiments, a custom pre-defined template is used as a second data model for creating the second representation of the source data to be stored as mapped data. In particular, the mapping module may comprise a custom data table module 157 that enables the creation of a custom data model by merging two or more source tables, each of which comprises a different set of source data. For example, clinical trial data corresponding to measurements from different subjects that are collected using different forms may be combined into a single data table by merging two or more data tables. Moreover, in order to provide a customized representation of the clinical trial data, individual fields of the source tables may be removed, and/or the data type of specific fields may be changed to better suit the needs of a particular stakeholder and/or client application. Embodiments of systems and methods for merging multiple tables of clinical trial data are provided in detail in the U.S. patent application entitled “Systems and Methods Employing Merge Technology for the Clinical Domain”, filed Aug. 25, 2016 (Attorney Docket No. 2010467-0109) the entire content of which is hereby incorporated herein by reference in its entirety.

In certain embodiments, the source data that is transformed to create the custom representation is represented using one of the aforementioned data models associated with a particular source of clinical trial, such as SDTM, ODM, or SAS® or Oracle® Argus specific data models.

In certain embodiments the clinical connector technology described herein comprises a specifications layer 170 that comprises one or more specifications modules (e.g. 171, 174, 177) each of which is associated with a specific standardized data model. In certain embodiments, the second data model that is used to create the second representation of the source data is one of the standardized data models with which each specifications module is associated. In particular, in certain embodiments the parsers of the mapping module may refer to the specifications modules 171, 174, 177 for instructions for creating the second representation of the source data from the intermediate, internal representation that is created by parsing the source data. For example, each specifications module 171, 174, 177 may comprise instructions for creating, from the intermediate representation, the second representation of the source data using a specific data model. For example, the specifications layer 170 may comprise a SDTM data model module 171, a CTMS data model module 174, and a safety and pharmacovigilance data model module 177. In this manner, new data models to be used for creating mapped data can be added in a scalable and pluggable fashion by adding corresponding specifications modules to the specifications layer 170.

In certain embodiments, the reporting, visualization and analytics module 190 comprises a reporting module 191 that creates (e.g. automatically generates) reports from underlying clinical trial data that is stored in the systems described herein. In certain embodiments, the reporting module automatically generates a report based on a pre-defined template, wherein the generated report comprises data from an aggregated data set created by the data aggregation module 130. In certain embodiments, the generated report may comprise mapped data that was created by parsing the retrieved source data. For instance, a report could be created to monitor the frequency of adverse events in one or more studies. Similarly, another report could be created to identify the occurrence of a specific type of adverse event.

In certain embodiments, the reporting, visualization and analytics module 190 comprises a visualization module 194 that generates (e.g. automatically, by a processor) a graphical representation of clinical trial data based on a pre-defined template. The pre-defined template may be created as per client specification or to analyze a particular domain specific scenario. Graphical representations of clinical trial data are useful for visualizing a specific set of data, or trend in data. Presenting data via a graphical representations may be preferable to a tabular representations, and assist stakeholders in analyzing clinical trial data. In certain embodiments, the visualization module 194 automatically generates a graphical representation of clinical trial data based on a pre-defined template, wherein the graphical representation comprises data from an aggregated data set created by the data aggregation module 130. In certain embodiments, the generated graphical representation comprises mapped data that was created by parsing the retrieved source data.

In certain embodiments, the reporting, visualization and analytics module 190 comprises an analytics module 197 that provides analytics functionality. In certain embodiments, analytics functionality comprises complex data mining and data processing techniques used to identify hidden relationships between data points, perform statistical analysis, and/or generate one or more derived variables. A derived variable is not directly measured, but instead is a function of two or more data points that are directly measured. For example, the age and weight of each subject may be recorded during a clinical trial, and a derived variable corresponding to the ratio of subject weight to age could be created. Derived variables may represent useful metrics for e.g. evaluating drug efficacy or predicting a response to treatment. In certain embodiments, the reports and visualizations generated by the reporting 191 and visualization modules 194, respectively, may comprise one or more derived variables.

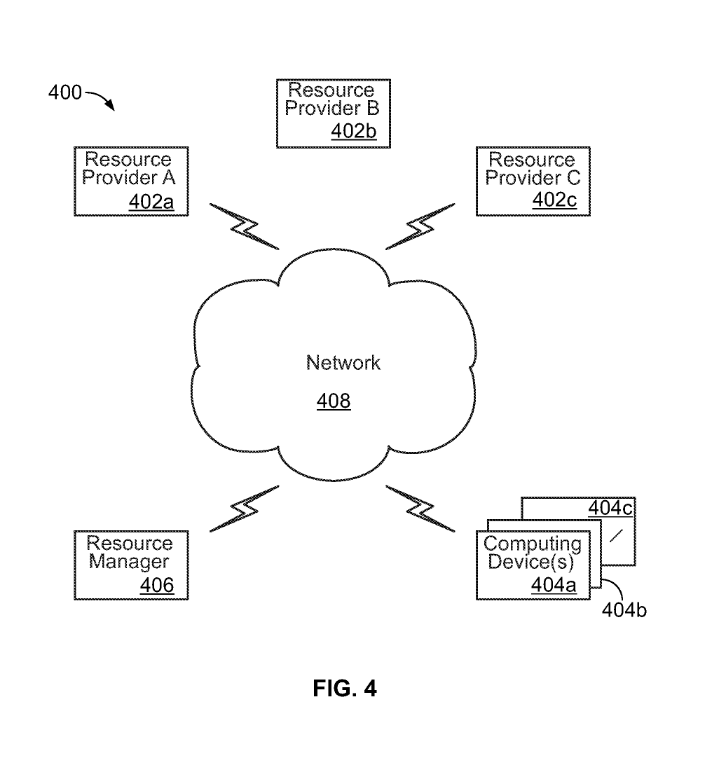

As shown in FIG. 4, an implementation of a network environment 400 for use in providing systems, methods, and architectures for retrieving, managing, and analyzing clinical trial data from a plurality of sources as described herein is shown and described. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

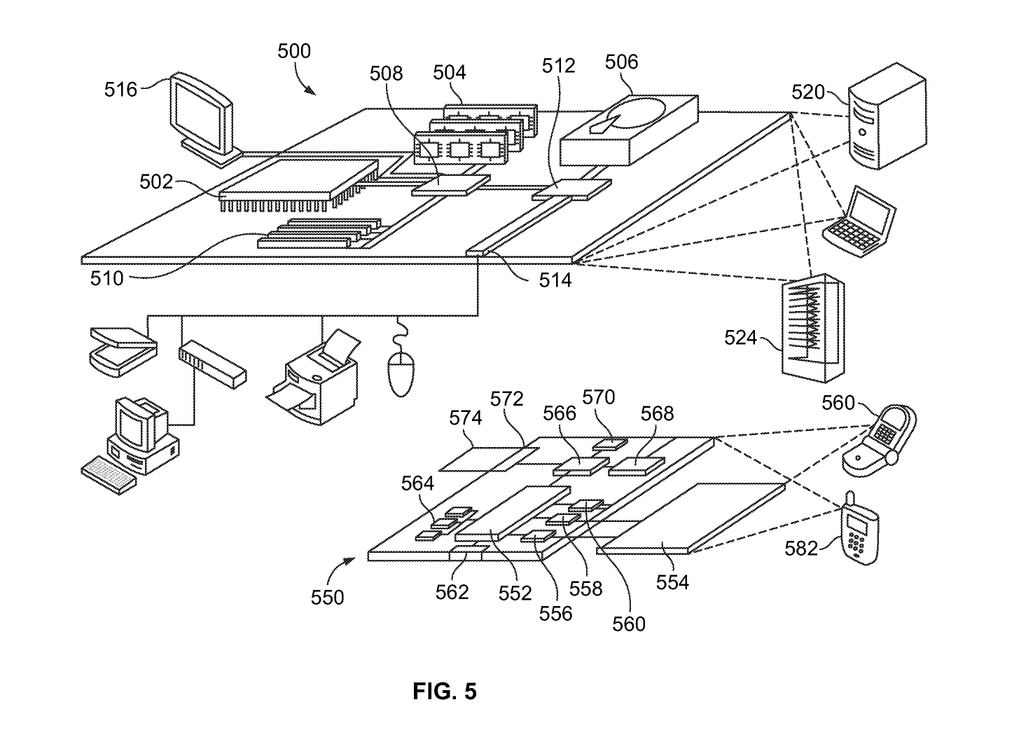

FIG. 5 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the modules (e.g. data aggregation module 130, mapping module 150, specifications module 170) described herein can be separated, combined or incorporated into single or combined modules. The modules depicted in the figures are not intended to limit the systems described herein to the software architectures shown therein.

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein. In view of the structure, functions and apparatus of the systems and methods described here, in some implementations.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

While the invention has been particularly shown and described with reference to specific preferred embodiments, it should be understood by those skilled in the art that various changes in form and detail may be made therein without departing from the spirit and scope of the invention as defined by the appended claims.

1. A method for retrieving, managing, and analyzing clinical trial data from a plurality of sources, the method comprising:
retrieving clinical trial data, by a processor of a computing device, from a selected one of the plurality of sources, via a function of an application programming interface (API) that causes the processor to:
select one of a set of pluggable connectors, wherein each connector of the set is associated with a specific one of the plurality of sources of clinical trial data and comprises one or more protocols that is/are specific to the associated source of clinical trial data; and
execute instructions pursuant to the one or more protocols of the selected connector to retrieve clinical trial data from the selected source; and
storing the retrieved clinical trial data, by the processor, as source data.

2. The method of claim 1, wherein the selected pluggable connector comprises one or more protocols specific to a source of clinical trial data selected from the group consisting of:
an electronic data capture (EDC) system;
a clinical trial management system (CTMS);
a pharmacovigilance (PV) system; and
a public data source.

3. The method of claim 1, comprising periodically requesting clinical trial data from the selected source of clinical trial data via the function of the API, and storing the retrieved clinical trial data as source data, thereby updating a cache of stored source data.

4. The method of claim 1 comprising storing the source data in a document-based database.

5. The method of claim 1, comprising:
retrieving clinical trial data from two or more selected sources of clinical trial data;
aggregating the clinical trial data retrieved from the two or more selected sources into a single aggregated set of clinical trial data; and
storing the aggregated set of clinical trial data for further processing and/or retrieval by a client application.

6. The method of claim 5, comprising automatically generating, by a processor of a computing device, a report based on a pre-defined template, wherein the generated report comprises clinical trial data from the aggregated set of clinical trial data.

7. The method of claim 5, comprising automatically generating, by a processor of a computing device, a graphical representation of clinical trial data based on a pre-defined template, wherein the graphical representation comprises clinical trial data from the aggregated set of clinical trial data.

8. The method of claim 1, comprising:
extracting metadata from the retrieved clinical trial data; and
storing the extracted metadata for further processing and/or retrieval by a client application.

9. The method of claim 1, comprising
retrieving, by the processor, the stored source data, wherein the retrieved source data has a first representation corresponding to a first data model associated with the source of clinical trial data from which it was retrieved;
parsing, by the processor, the retrieved source data to create an intermediate representation of the source data;
creating, by the processor, a second representation of the source data from the intermediate representation of the source data using a second data model; and
storing the second representation of the source data as mapped data for further retrieval and/or processing.

10. The method of claim 9, wherein the first data model is a data model selected from the group consisting of:
a Clinical Data Interchange Standards Consortium (CDISC) Study Data Tabulation Model (SDTM);
a Clinical Data Interchange Standards Consortium (CDISC) Operational Data Model (ODM);
an Operational Data Model (ODM) compliant data model specific to a third party EDC system;
a data model specific to a third party CTMS system; and
a data model specific to a third part pharmacovigilance system.

11. The method of claim 9, wherein the second data model is a member selected from the group consisting of:
a Clinical Data Interchange Standards Consortium (CDISC) Study Data Tabulation Model (SDTM),
a Clinical Trial Management System (CTMS) compliant data model, and
a safety and pharmacovigilance data model.

12. The method of claim 9, wherein the second data model is a custom data model.

13. The method of claim 9, comprising automatically generating, by a processor of a computing device, a report based on a pre-defined template, wherein the generated report comprises at least a portion of the mapped data.

14. The method of claim 9, comprising automatically generating, by a processor of a computing device, a graphical representation of the mapped clinical trial data based on a pre-defined template, wherein the graphical representation comprises at least a portion of the mapped data.

15. A system for retrieving, managing, and analyzing clinical trial data from a plurality of sources, the system comprising:
a memory for storing a set of instructions; and
a processor for executing the instructions, wherein the instructions, when executed, cause the processor to:
retrieve clinical trial data from a selected one of the plurality of sources via a function of an application programming interface (API) that causes the processor to:
select one of a set of pluggable connectors, wherein each connector of the set is associated with a specific one of the plurality of sources of clinical trial data and comprises one or more protocols that is/are specific to the associated source of clinical trial data; and
execute instructions pursuant to the one or more protocols of the selected connector to retrieve clinical trial data from the selected source; and
store the retrieved clinical trial data, by the processor, as source data.

16.-28. (canceled)

29. A clinical connector system for retrieving, managing, and analyzing clinical trial data from a plurality of sources, the system comprising:
a data services module for retrieving clinical trial data from a plurality of sources and storing the retrieved clinical trial data as source data, the data services module comprising an application programming interface (API) for:
selecting one of a set of pluggable connectors, wherein each connector of the set is associated with a specific one of the plurality of sources of clinical trial data and comprises one or more protocols that is/are specific to the associated source of clinical trial data; and
retrieving clinical trial data from the selected source pursuant to the one or more protocols of the selected connector.

30. The system of claim 29, wherein the set of pluggable connectors comprises one or more protocols specific to a source of clinical trial data selected from the group consisting of:
an electronic data capture (EDC) system;
a clinical trial management system (CTMS);
a pharmacovigilance (PV) system; and
a public data source.

31. The system of claim 29, wherein the data services module periodically requests clinical trial data from the selected source of clinical trial data via a function of the API, and stores the retrieved clinical trial data as source data, thereby updating a cache of stored source data.

32. The system of claim 29, wherein the data services module stores the retrieved clinical trial data as source data in a document-based database.

33. The system of claim 29, wherein the data services module:
retrieves clinical trial data from two or more selected sources of clinical trial data;
aggregates the clinical trial data retrieved from the two or more selected sources into a single aggregated set of clinical trial data; and
stores the aggregated set of clinical trial data for further processing and/or retrieval by a client application.

34. The system of claim 33, comprising a reporting module for automatically generating, by a processor of a computing device, a report based on a pre-defined template, wherein the generated report comprises clinical trial data from the aggregated set of clinical trial data.

35. The method of claim 33, comprising a visualization module for automatically generating, by a processor of a computing device, a graphical representation of clinical trial data based on a pre-defined template, wherein the graphical representation comprises clinical trial data from the aggregated set of clinical trial data.

36. The system of claim 29, comprising a semantic data catalogue module for extracting metadata from the retrieved clinical trial data, and storing the extracted metadata for further processing and/or retrieval by a client application.

37. The system of claim 29, comprising a mapping module for:
retrieving the stored source data, wherein the retrieved source data has a first representation corresponding to a first data model associated with the source of clinical trial data from which it was retrieved;
creating a second representation of the retrieved source data using a second data model; and
storing the second representation of the retrieved source data as mapped data for further retrieval and/or processing.

38. The system of claim 37, wherein:
the first data model is one of a plurality of source data models, each source data model associated with a specific one of the plurality of sources of clinical trial data,
the mapping module comprises a plurality of parsers, and
creating the second representation of the retrieved source data using a second data model comprises selecting a parser that is associated with the first data model and executing the instructions of the selected parser to parse the source data, create an intermediate representation, and create the second representation, wherein:
the selected parser is one of the plurality of parsers,
each parser is associated with a specific one of the plurality of source data models, and
each parser comprises instructions which, when executed by a processor of a computing device, cause the processor to:
parse source data having a representation corresponding to the specific source data model with which the parser is associated to create an intermediate representation of the source data; and
create the second representation of the source data from the intermediate representation of the source data using the second data model.

39. The system of claim 37, comprising one or more specifications modules, wherein
the first data model is one of a plurality of source data models, each source data model being associated with a specific one of the plurality of sources of clinical trial data,
the second data model is one of one or more standardized data models,
the mapping module comprises a plurality of parsers, and
creating the second representation of the retrieved source data using the second data model comprises:
(i) selecting a parser that is associated with the first data model and executing the instructions of the selected parser to create an intermediate representation of the source data, wherein:
the selected parser is one of the plurality of parsers,
each parser is associated with a specific one of the plurality of source data models, and
each parser comprises instructions which, when executed by a processor of a computing device, cause the processor to:
parse source data having a representation corresponding to the specific source data model with which the parser is associated to create an intermediate representation of the source data; and
(ii) selecting a specifications module that is associated with the second data model to create the second representation from the intermediate representation, wherein:
the selected specifications module is one of the one or more specifications modules,
each of the one or more specifications modules is associated with a specific one of the one or more standardized data models, and
each specifications module comprises instructions which, when executed by a processor of a computing device, cause the processor to create a representation of the source data from the intermediate representation of the source data using the specific standardized data model with which the specifications module is associated.

40. The system of claim 37, wherein the first data model is a data model selected from the group consisting of:
a Clinical Data Interchange Standards Consortium (CDISC) Study Data Tabulation Model (SDTM);
a Clinical Data Interchange Standards Consortium (CDISC) Operational Data Model (ODM);
an Operational Data Model (ODM) compliant data model specific to a third party EDC system;
a data model specific to a third party CTMS system; and
a data model specific to a third part pharmacovigilance system.

41. The system of claim 37, wherein the second data model is a member selected from the group consisting of:
a Clinical Data Interchange Standards Consortium (CDISC) Study Data Tabulation Model (SDTM),
a Clinical Trial Management System (CTMS) compliant data model, and
a safety and pharmacovigilance data model.

42. The system of claim 37, wherein the second data model is a custom data model.

43. The system of claim 37, comprising a reporting module for automatically generating, by a processor of a computing device, a report based on a pre-defined template, wherein the generated report comprises at least a portion of the mapped data.

44. The system of claim 37, comprising a visualization module for automatically generating, by a processor of a computing device, a graphical representation of the mapped clinical trial data based on a pre-defined template, wherein the graphical representation comprises at least a portion of the mapped data.
